(19) United States
(12) Patent Application Publication
(10) Pub. No.: US 2006/0184701 A1
(43) Pub. Date: Aug. 17, 2006

(54) Position changing apparatus

(76) Inventor: Wan Sung Hur, Asan-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/265,944

(22) Filed: Nov. 3, 2005

(30) Foreign Application Priority Data
Nov. 24, 2004 (KR) 10-2004-0097085

(51) Int. Cl. G06F 9/44

(52) U.S. Cl. 710/1

(57) ABSTRACT

The present invention provides a position changing apparatus for moving a vehicle body or a vehicle part that includes a jig base, a guide unit forming a slanted guide surface, a driving block, an actuator, and an attaching unit. In addition, all components of the position changing apparatus are simplified, thereby reducing the incidences of malfunctions and the costs for maintaining and repairing. Moreover, the position changing apparatus occupies a smaller area than one of the prior art.

### CROSS REFERENCE TO RELATED APPLICATION

This application claims priority to Korean Application No. 10-2004-0097085, filed on Nov. 24, 2004, and the disclosure of which is incorporated herein by reference in its entirety.

### FIELD OF THE INVENTION

The present invention generally relates to a position changing apparatus for moving a vehicle body or a vehicle part.

### BACKGROUND OF THE INVENTION

A position changing apparatus for moving a vehicle body or a vehicle part to a required position is generally used in a vehicle assembly line.

In order to move the vehicle body or the vehicle part, the position changing apparatus needs two actuators, two guides, two blocks, two solenoid valves, and four sensors. Therefore, a control circuit for controlling the two actuators becomes complicated. In addition, because two actuators, two guides, two blocks, and two solenoid valves are needed, the position changing apparatus has a problem in that time and costs for maintaining and repairing the components substantially increase. The position changing apparatus also has a problem in that an area of the position changing apparatus is enlarged.

The information disclosed in this section is only for enhancement of understanding of the background of the invention and should not be taken as an acknowledgement or any form of suggestion that this information forms the prior art that is already known in this country to a person of ordinary skill in the art.

### SUMMARY OF THE INVENTION

The present invention provides a position changing apparatus having non-limiting advantages of moving a vehicle body or a vehicle part.

According to an embodiment of the present invention, an exemplary position changing apparatus includes a jig base, a guide unit forming a slanted guide surface and being mounted on the jig base, a driving block mounted to the guide unit to be movable along the slanted guide surface of the guide unit, an actuating unit for moving the driving block, and an attaching unit mounted to the driving block and configured to temporarily attach the vehicle body or the vehicle part.

The guide unit comprises a guide base mounted on the jig base, and a slanted guide forming the slanted guide surface and being mounted to the guide base.

Stoppers for limiting movement of the driving block are provided on both ends of the guide unit.

The actuating unit comprises an actuating cylinder. In particular, the actuating unit comprises a cylinder housing configured to receive operating fluid; a piston disposed in the cylinder housing to be movable depending on a pressure of the operating fluid supplied to the cylinder housing; a connecting rod connecting the piston with the driving block; a solenoid valve for regulating the pressure of the operating fluid supplied to the cylinder housing; a plurality of position sensors mounted to the cylinder housing, the plurality of position sensors detecting a position of the piston and outputting a corresponding signal; and a control unit for controlling an operation of the solenoid valve on the basis of the signals output from the plurality of the position sensors.

The plurality of position sensors comprises a first position sensor and a second position sensor that are respectively disposed on both ends of the cylinder housing.

### BRIEF DESCRIPTION OF THE DRAWINGS

The accompanying drawings illustrate exemplary embodiments of the present invention, and, together with the description, serve to explain the principles of the present invention, wherein:

FIG. 1 is schematic view of a position changing apparatus according to an embodiment of the present invention.

### DETAILED DESCRIPTION OF THE EMBODIMENTS

An embodiment of the present invention will hereinafter be described in detail with reference to the accompanying drawings.

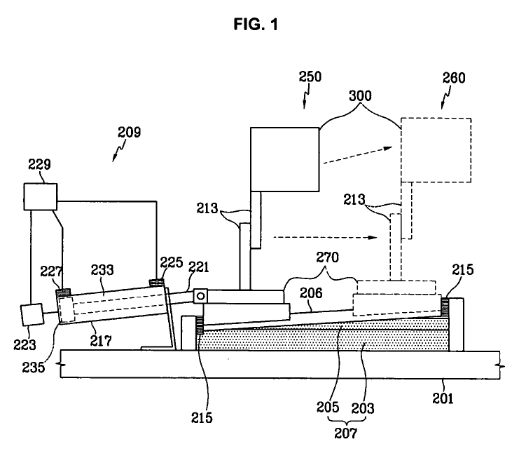

FIG. 1 is schematic view of a position changing apparatus according to an embodiment of the present invention.

As shown in FIG. 1, the position changing apparatus includes a jig base 201, a guide unit 207, a driving block 270, an actuating unit 209, and an attaching unit 213. The jig base 201 may form a lower portion of the position changing apparatus according to an embodiment of the present invention, and the guide unit 207 is mounted on the jig base 201. The guide unit 207 forms a slanted surface 206, both ends of which have different heights. In this embodiment of the present invention, an end of the slanted guide surface 206 that is closer to the actuating unit 209 than the other end is formed to be the lower of the two. However, it is easily understood that the shape of the slanted guide surface 206 is not limited thereto. The guide unit 207 includes a guide base 203 and a slanted guide 205. The guide base 203 may be mounted on the jig base 201, and the slanted guide 205 may be mounted on the guide base 203 such that the slanted guide surface 206 is formed.

In another embodiment of the present invention, the guide base may be formed to be slanted, and the guide may be formed as a flat plate. Therefore, by disposing the flat guide on the slanted guide base, the slanted surface can be realized.

The driving block 270 is mounted on the guide unit 207 such that the driving block 270 can move along the guide surface 206 of the guide unit 207. More particularly, the driving block 270 is movably mounted on the slanted guide 205 of the guide unit 207. The driving block 270 is tapered such that an upper surface of the driving block 270 is flat.

A bearing (not shown) can be disposed between the driving block 270 and the guide surface 206 to decrease friction between the driving block 270 and the guide unit 207.

The actuating unit 209 is configured to move the driving block 270. The actuating unit 209 is connected to the driving block 270, and the driving block 270 is urged to move along the slanted guide 205 by the force transmitted from the actuating unit 209.

The attaching unit 213 is fixed to the driving block 270 and is formed to temporarily attach the vehicle body or the vehicle part 300. For example, as shown in FIG. 1, the attaching unit 213 is fixed to the driving block 270. Although in this embodiment the attaching unit 213 includes two members, the attaching unit 213 can also be realized as a single member.

The actuating unit 209 includes an actuating cylinder 217 for moving the driving block 270. According to another embodiment of the present invention, the actuating unit 209 further includes a solenoid valve 223, position sensors 227 and 225, and an electronic control unit (ECU) 229, in addition to the actuating cylinder 217.

The actuating cylinder 217 can be realized as a pneumatic cylinder, a hydraulic cylinder, or any cylinder that can move the driving block 270, and the cylinder can include a cylinder housing 233, a piston 235, and a connecting rod 221. The cylinder housing 233 is formed such that it can be supplied with operating fluid, and the piston 235 is disposed within the cylinder housing 233 such that the piston 235 can move in response to the operating fluid pressure. The connecting rod 221 connects the piston 235 with the driving block 270. Therefore, the driving block 270 is urged to move on the guide unit 207 by the pressure of the operating fluid supplied to the actuating cylinder 217. The pressure of the operating fluid supplied to the cylinder housing 233 is regulated by the solenoid valve 223.

A plurality of position sensors 225 and 227 are mounted to the cylinder housing 233. The plurality of position sensors 225 and 227 detect a position of the piston 235 and output a corresponding signal to the ECU 229. For example, when the piston 235 is located in front of the position sensors 225 and 227, the position sensors 225 and 227 may detect the position of the piston 235 and output a corresponding signal.

The ECU 223 can be realized by one or more processors activated by a predetermined program, and the predetermined program can be programmed to perform each step of the method for controlling the solenoid valve 223 according to an embodiment of the present invention.

The plurality of position sensors 225 and 227 includes a first position sensor 225 and a second position sensor 227 that are respectively disposed on both ends of the cylinder housing 233. Consequently, due to the first and second position sensors 225 and 227, they can detect whether the piston 235 is positioned at an end of the cylinder housing 233.

The ECU 229 controls the solenoid valve 223 on the basis of the signal transmitted from the plurality of position sensors 225 and 227 and an external signal.

In the case of receiving the signal output from the second position sensor 227 and an external position changing signal (e.g., from a driver or another control unit), such as when the position changing signal is transmitted from the outside in a state that the piston 235 is located in a position in which the second position sensor 227 is located, the ECU 229 outputs a control signal for controlling the solenoid valve 223 such that the operating fluid is supplied to the cylinder housing 233.

If the operating fluid is supplied to the cylinder housing, the piston 235 is urged to move in the rightward direction in FIG. 1. As the piston 235 moves in the rightward direction, the driving block 270 connected to the connecting rod 221 moves in a right upward direction along the slanted guide surface 206. Thus, the driving block 270 and the attaching unit 213 also move in the right upward direction. Consequently, the vehicle body or the vehicle part 300 attached to the attaching unit 213 is moved from a first position 250 to a second position 260 (i.e., moved in the arrow direction shown in FIG. 1).

In addition, in the case of receiving the signal output from the first position sensor 225 and an external position changing signal (e.g., from a driver or another control unit), such as when the position changing signal is transmitted from the outside in a state in which the piston 235 is located in a position in which the first position sensor 225 is located, the ECU 229 outputs a control signal for controlling the solenoid valve 223 such that the operating fluid is exhausted from the cylinder housing 233. In this case, the vehicle body or the vehicle part 300 is moved from the second position 260 to the first position 250.

As described above, the vehicle body or the vehicle part 300 can be moved from the first position 250 to the second position 260 or from the second position 260 to the first position 250 by one actuating unit 209 in a slanted direction.

At both ends of the guide unit 207, a stopper 215 for limiting movement of the driving block 270 may be mounted.

According to the embodiments of the present invention, because the position changing apparatus can change position of the vehicle body or the vehicle part by the slanted guide unit, the position changing apparatus can operate with one actuator. Therefore, components of the position changing apparatus are more simplified. In addition, because of the simplicity of the components, incidences of malfunctions and costs for maintenance and repair are reduced, and the position changing apparatus occupies a smaller area.

While this invention has been described in connection with the most practical exemplary embodiments, it is to be understood that the invention is not limited to the disclosed embodiments, but, on the contrary, it is intended to cover various modifications and equivalent arrangements included within the spirit and scope of the appended claims.

What is claimed is:

1. A position changing apparatus for moving a vehicle body or a vehicle part, comprising:
a jig base;
a guide unit forming a slanted guide surface and being mounted on the jig base;
a driving block mounted to the guide unit to be movable along the slanted guide surface of the guide unit;
an actuating unit for moving the driving block; and
an attaching unit mounted to the driving block and configured to temporarily attach a vehicle body or a vehicle part.

2. The position changing apparatus of claim 1, wherein the guide unit comprises:
a guide base mounted on the jig base; and
a slanted guide forming the slanted guide surface and being mounted to the guide base.

3. The position changing apparatus of claim 1, wherein the actuating unit comprises an actuating cylinder.

4. The position changing apparatus of claim 1, wherein stoppers for limiting movement of the driving block are provided on both ends of the guide unit.

5. The position changing apparatus of claim 1, wherein the actuating unit comprises:
a cylinder housing configured to receive operating fluid;
a piston disposed in the cylinder housing to be movable depending on a pressure of the operating fluid supplied to the cylinder housing;
a connecting rod connecting the piston with the driving block;
a solenoid valve for regulating the pressure of the operating fluid supplied to the cylinder housing;
a plurality of position sensors mounted to the cylinder housing, the plurality of position sensors detecting a position of the piston and outputting corresponding signals; and
a control unit for controlling an operation of the solenoid valve on the basis of the signals output from the plurality of the position sensors.

6. The position changing apparatus of claim 5, wherein the plurality of the position sensors comprise a first position sensor and a second position sensor that are respectively disposed on both ends of the cylinder housing.
